(19) United States
(12) Patent Application Publication
(10) Pub. No.: US 2024/0173113 A1
(43) Pub. Date: May 30, 2024

(54) MULTIPURPOSE DENTAL CLEANING DEVICE

(71) Applicant: Erin Small, Slidell, LA (US)

(72) Inventor: Erin Small, Slidell, LA (US)

(21) Appl. No.: 17/994,483

(22) Filed: Nov. 28, 2022

(51) Int. Cl. A61C 17/22; A61C 15/04; A61C 17/34

(52) U.S. Cl. CPC A61C 17/225; A61C 15/047; A61C 17/3454

(57) ABSTRACT

A multipurpose dental cleaning device, including a main body to facilitate gripping thereof, a plurality of bristles disposed on at least a portion of a first end of the main body to brush at least one tooth, and a floss compartment disposed within at least a portion of a second end of the main body, the floss compartment including a compartment body to store a line of floss therein, a roll of floss movably disposed within at least a portion of the compartment body to coil the line of floss, a floss dispensing aperture disposed on at least a portion of the compartment body to facilitate extraction of the line of floss from within the compartment body, and a plurality of floss holders movably disposed on at least a portion of the compartment body to hold the line of floss on at least a portion thereof, and a motor disposed within at least a portion of the main body to perform at least one of vibrate the plurality of bristles and oscillate the roll of floss.

### BACKGROUND

### 1. Field

The present general inventive concept relates generally to dental cleaning, and particularly, to a multipurpose dental cleaning device.

### 2. Description of the Related Art

Cleaning teeth is an important oral practice and minimizes tooth decay and plaque buildup. Unfortunately, many people neglect flossing as part of their daily teeth cleaning. In fact, studies have shown that less than fifty percent of people actually floss on a daily basis. Moreover, many people often claim that physical dexterity is a problem when managing the floss while others complain about the time and overall inconvenience it is to extend their oral care regimen.

Floss is often supplied in a container as a separate accessory from a toothbrush. In other words, a floss dispenser must be purchased to use the floss after the toothbrush is used. The floss dispenser is a small container that can be easily lost and/or misplaced.

Therefore, there is a need for a multipurpose dental cleaning device that combines the floss dispenser with the toothbrush that encourages a user to floss.

### SUMMARY

The present general inventive concept provides a multipurpose dental cleaning device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a multipurpose dental cleaning device, including a main body to facilitate gripping thereof, a plurality of bristles disposed on at least a portion of a first end of the main body to brush at least one tooth, and a floss compartment disposed within at least a portion of a second end of the main body, the floss compartment including a compartment body to store a line of floss therein, a roll of floss movably disposed within at least a portion of the compartment body to coil the line of floss, a floss dispensing aperture disposed on at least a portion of the compartment body to facilitate extraction of the line of floss from within the compartment body, and a plurality of floss holders movably disposed on at least a portion of the compartment body to hold the line of floss on at least a portion thereof, and a motor disposed within at least a portion of the main body to perform at least one of vibrate the plurality of bristles and oscillate the roll of floss.

Each of the plurality of floss holders may move from retracted within the compartment body in a first position to at least partially extracted from the compartment body in a second position, and moves from extracted from the compartment body in the second position to retracted within the compartment body in the first position.

The plurality of floss holders may be flush with at least one of an edge of the compartment body and an edge of the main body in the first position.

The plurality of floss holders may suspend the line of floss therebetween a distance away from the compartment body.

The plurality of floss holders may vibrate the line of floss in response to movement by the motor.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a multipurpose dental cleaning device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Multipurpose Dental Cleaning Device 100
Main Body 110
Handle 111
Neck 112
Head 113
Bristles 120
Floss Compartment 130
Compartment Body 131
Floss Roll 132
Floss Dispensing Aperture 133
Floss Holders 134
Tongue Scraper 140
Motor 150
Control Buttons 160
Brushing Button 161
Floss Button 162
Power Source 170

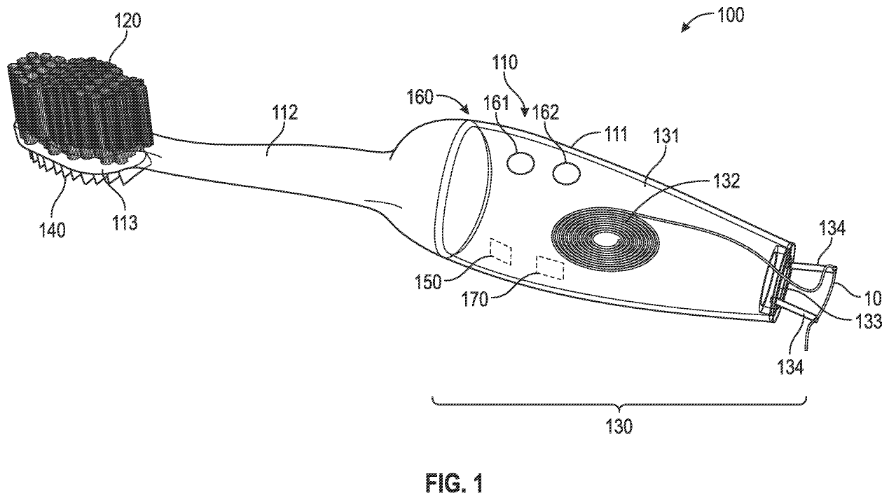

FIG. 1 illustrates a side perspective view of a multipurpose dental cleaning device 100, according to an exemplary embodiment of the present general inventive concept.

The multipurpose dental cleaning device 100 may be constructed from at least one of metal, plastic, wood, and rubber, etc., but is not limited thereto.

The multipurpose dental cleaning device 100 may include a main body 110, a plurality of bristles 120, a floss compartment 130, a tongue scraper 140, a motor 150, a plurality of control buttons 160, and a power source 170, but is not limited thereto.

The main body 110 may include a handle 111, a neck 112, and a head 113, but is not limited thereto.

The handle 111 may have a bulbous shape. Moreover, the handle 111 may be at least partially rounded to increase comfort during holding and/or use. In other words, the handle 111 may facilitate gripping thereof.

The neck 112 may be disposed at a first end on at least a portion of a first end of the handle 111. Moreover, the neck 112 may have a size (e.g., length, width) and/or a shape different than a remainder of the handle 111. For example, the size and/or the shape of the neck 112 may be smaller than a size (e.g., length, width) and/or a shape of the handle 111. Also, the neck 112 may be narrower and/or elongate with respect to the remainder of the handle 111, such that the neck 112 may be at least partially inserted into a mouth of a user.

The head 113 may be disposed on at least a portion of the first end of the handle 111. Also, the head 113 may be disposed at a second end of the neck 112.

The plurality of bristles 120 may be constructed to be soft bristles, hard bristles, and/or any combination thereof, but is not limited thereto. More specifically, hard bristles may be more rigid compared to soft bristles. In other words, soft bristles may at least partially deform (i.e., bend, flex) in response to contact with at least one tooth. As such, the soft bristles may prevent abrasion to the at least one tooth and/or gums.

The plurality of bristles 120 may be disposed on at least a portion of the second end of the neck 112. Also, the plurality of bristles 120 may be perpendicularly disposed away from a surface of a first side of the head 113 with respect to a first direction. As such, the plurality of bristles 120 may brush the at least one tooth while at least partially inserted into the mouth of the user.

The floss compartment 130 may include a compartment body 131, a floss roll 132, a floss dispensing aperture 133, and a plurality of floss holders 134, but is not limited thereto.

The compartment body 131 may be disposed on and/or within at least a portion of the handle 111. The compartment body 131 may receive and/or store a line of floss 10 therein.

The floss roll 132 may be movably (i.e., rotatably) disposed within the compartment body 131, such that the line of floss 10 is coiled within the compartment body 131. Furthermore, the floss roll 132 may rotate in response to the line of floss 10 being extracted from the compartment body 131.

The floss dispensing aperture 133 may be disposed on at least a portion of the compartment body 131 at a second end of the handle 111. The floss dispensing aperture 133 may receive the line of floss 10 therethrough and/or facilitate extraction of the line of floss 10 from within the compartment body 131.

The plurality of floss holders 134 may be movably (i.e., pivotally, foldably) disposed on at least a portion of the second end of the handle 111 and/or on the compartment body 131. More specifically, each of the plurality of floss holders 134 may move (i.e., rotate) from retracted (i.e., folded) within the compartment body 131 in a first position to at least partially extracted from the compartment body 131 in a second position, such that the plurality of floss holders 134 may be flush with an edge of the compartment body 131 and/or an edge of the handle 111 in the first position. Conversely, each of the plurality of floss holders 134 may move (i.e., rotate) from extracted from the compartment body 131 in the second position to retracted (i.e., folded) within the compartment body 131 in the first position. Thus, each of the plurality of floss holders 134 may hold the line of floss 10 on at least a portion thereof, such that the line of floss 10 is suspended therebetween a distance away from the compartment body 131 and the floss dispensing aperture 133 in the second position.

Furthermore, each of the plurality of floss holders 134 may have a blade to cut the line of floss 10. As such, each of the plurality of floss holders 134 may separate the line of floss 10 from the floss roll 132, such that the line of floss 10 may be used by the user to extract at least one particle of food disposed between the teeth.

The tongue scraper 140 may include a plurality of bulbous protrusions. Also, the tongue scraper 140 may be soft and/or hard. More specifically, the tongue scraper 140 being hard may be more rigid compared to being soft. In other words, the tongue scraper 140 being soft may at least partially deform (i.e., bend, flex) in response to contact with a tongue of the user.

The tongue scraper 140 may be disposed on at least a portion of the second end of the neck 112. More specifically, the tongue scraper 140 may be perpendicularly disposed away from a surface of a second side of the head 113 with respect to a second direction opposite with respect to the first direction. Also, the second side of the head 113 may be disposed opposite with respect to the first side of the head 113. Accordingly, the tongue scraper 140 may be disposed opposite with respect to the plurality of bristles 120. Therefore, the tongue scraper 140 may facilitate cleaning of the tongue of the user in response to contact with the tongue by extracting at least one particle of food from the tongue.

The motor 150 may be disposed within at least a portion of the handle 111, and/or connected to the plurality of bristles 120 and/or the floss roll 132. The plurality of bristles 120 may vibrate in response to movement of the motor 150. The plurality of bristles 120 may loosen at least one particle of food on the at least one tooth in response to vibrating.

Additionally, the floss roll 132 may move (i.e., rotate, spin) and/or each of the plurality of floss holders 134 may move (i.e., vibrate) in response to movement of the motor 150. As such, the line of floss 10 may move (i.e., oscillate, move in a lateral direction) out of the floss dispensing aperture 133 and/or back and forth (i.e., in and out) through the floss dispensing aperture 133 to facilitate flossing of the at least one tooth. Also, the plurality of floss holders 134 may vibrate to loosen the at least one particle of food on the at least one tooth using the line of floss 10.

The plurality of control buttons 160 may include a brushing button 161 and a floss button 162, but is not limited thereto.

The brushing button 161 may be disposed on at least a portion of the handle 111. The brushing button 161 may turn on the plurality of bristles 161 using the motor 150 in response to being depressed a first time, and turn off the plurality of bristles 161 in response to being depressed a second time.

Similarly, the floss button 162 may be disposed on at least a portion of the handle 111. The floss button 162 may turn on the floss roll 132 and/or the plurality of floss holders 134 using the motor 150 in response to being depressed a first time, and turn off the plurality of bristles 161 in response to being depressed a second time.

The power source 170 may include a battery and a solar cell, but is not limited thereto.

The power source 170 may be disposed on and/or within at least a portion of the main body 110. The power source 170 may send power to the plurality of bristles 120, the floss compartment 130, the motor 150, and/or the plurality of control buttons 160.

Therefore, the multipurpose dental cleaning device 100 may provide a convenient solution for maintaining oral health. The dental cleaning device 100 may allow teeth to be cleaned through brushing as well as conveniently providing the line of floss 10 for additional cleaning. Also, the dental cleaning device 100 may be used manually and/or electronically to clean teeth.

The present general inventive concept may include a multipurpose dental cleaning device 100, including a main body 110 to facilitate gripping thereof, a plurality of bristles 120 disposed on at least a portion of a first end of the main body 110 to brush at least one tooth, and a floss compartment 130 disposed within at least a portion of a second end of the main body 110, the floss compartment 130 including a compartment body 131 to store a line of floss 10 therein, a roll of floss 132 movably disposed within at least a portion of the compartment body 131 to coil the line of floss 10, a floss dispensing aperture 133 disposed on at least a portion of the compartment body 133 to facilitate extraction of the line of floss 10 from within the compartment body 131, and a plurality of floss holders 134 movably disposed on at least a portion of the compartment body 131 to hold the line of floss 10 on at least a portion thereof, and a motor 150 disposed within at least a portion of the main body to perform at least one of vibrate the plurality of bristles and oscillate the roll of floss.

Each of the plurality of floss holders 134 may move from retracted within the compartment body 131 in a first position to at least partially extracted from the compartment body 131 in a second position, and moves from extracted from the compartment body 131 in the second position to retracted within the compartment body 131 in the first position.

The plurality of floss holders 134 may be flush with at least one of an edge of the compartment body 131 and an edge of the main body 110 in the first position.

The plurality of floss holders 134 may suspend the line of floss 10 therebetween a distance away from the compartment body 131.

The plurality of floss holders 134 may vibrate the line of floss 10 in response to movement by the motor 150.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A multipurpose dental cleaning device, comprising:
a main body to facilitate gripping thereof;
a plurality of bristles disposed on at least a portion of a first end of the main body to brush at least one tooth;
a floss compartment disposed within at least a portion of a second end of the main body, the floss compartment comprising:
a compartment body to store a line of floss therein,
a roll of floss movably disposed within at least a portion of the compartment body to coil the line of floss,
a floss dispensing aperture disposed on at least a portion of the compartment body to facilitate extraction of the line of floss from within the compartment body, and
a plurality of floss holders movably disposed on at least a portion of the compartment body to hold the line of floss on at least a portion thereof; and
a motor disposed within at least a portion of the main body to perform at least one of vibrate the plurality of bristles and oscillate the roll of floss.

2. The multipurpose dental cleaning device of claim 1, wherein each of the plurality of floss holders moves from retracted within the compartment body in a first position to at least partially extracted from the compartment body in a second position, and moves from extracted from the compartment body in the second position to retracted within the compartment body in the first position.

3. The multipurpose dental cleaning device of claim 2, wherein the plurality of floss holders are flush with at least one of an edge of the compartment body and an edge of the main body in the first position.

4. The multipurpose dental cleaning device of claim 1, wherein the plurality of floss holders suspend the line of floss therebetween a distance away from the compartment body.

5. The multipurpose dental cleaning device of claim 1, wherein the plurality of floss holders vibrate the line of floss in response to movement by the motor.
